(19) United States
(12) Patent Application Publication
(10) Pub. No.: US 2009/0192878 A1
(43) Pub. Date: Jul. 30, 2009

(54) METHOD AND APPARATUS FOR UTILIZING SHOPPING SURVEY DATA

(75) Inventors: Bernard Lefang, Erie, CO (US); Cheryl M. Flink, Berthoud, CO (US)

Correspondence Address: SWANSON & BRATSCHUN, L.L.C., 8210 SOUTHPARK TERRACE, LITTLETON, CO, 80120, US

(73) Assignee: MARKET FORCE INFORMATION, INC., Boulder, CO (US)

(21) Appl. No.: 12/351,445

(22) Filed: Jan. 9, 2009

Related U.S. Application Data
(60) Provisional application No. 61/023,363, filed on Jan. 24, 2008.

(51) Int. Cl. G06Q 10/00

(52) U.S. Cl. 705/10

(57) ABSTRACT

In accordance with one embodiment of the invention, mystery shopping data may now be used in conjunction with customer satisfaction data to determine customer loyalty results. For example, two different surveys can be conducted: 1) a customer satisfaction survey of actual customers; and 2) a mystery shopper survey of store operational performance, assessing specific behaviors. The information can then be used to determine how a change in operations can affect the customer loyalty. Furthermore, other financial determinations that depend on customer loyalty can be determined as well in accordance with other embodiments.

### CROSS-REFERENCES TO RELATED APPLICATIONS

This application claims the benefit of U.S. provisional application 61/023,363 filed on Jan. 24, 2008 entitled “Method and Apparatus for Determining the Effect of Mystery Shopping Information on Customer Loyalty” the content of which is hereby incorporated by reference in its entirety and for all purposes.

### STATEMENT AS TO RIGHTS TO INVENTIONS MADE UNDER FEDERALLY SPONSORED RESEARCH AND DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND

Business owners have tried to improve the operation of their businesses by evaluating investments in different areas, such as real estate, employee training, production materials, pricing strategies, facilities maintenance, and inventory. The challenge has been to provide the appropriate amount of investment in the appropriate category or categories so as to achieve the desired improvement in the business. Obviously, this evaluation poses a difficult challenge to any business owner.

In the past, business owners have sometimes relied upon an assessment of customer satisfaction data to determine the potential impact on key financial metrics, such as in-store sales. However, use of this customer satisfaction data has not proved to be particularly effective. Typical key driver analyses of customer perceptions failed to extend the analysis of loyalty to actual behaviors that created those perceptions. As a result, businesses incorrectly assumed that they should make business investment decisions based purely on customer satisfaction in an attempt to improve customer loyalty and financial performance (e.g., same store sales). This misconception has resulted in the business spending money inefficiently on changes to business operations that do not produce the greatest improvement in customer loyalty.

Thus, there is a need for a system that can more accurately determine the effect that a change in a business' operations will have on customer satisfaction, customer loyalty, and/or financial return.

### SUMMARY

In accordance with one embodiment, a method of evaluating a targeted business can be performed which is comprised of obtaining customer satisfaction survey data, the customer satisfaction survey data gathered from a survey of a statistically significant sample of customers of the targeted business; obtaining mystery shopping data, the mystery shopping data gathered from a mystery shopping survey of the targeted business; modeling the targeted business with a statistical computer model, wherein the modeling comprises utilizing the customer satisfaction survey data in the statistical computer model; and utilizing the mystery shopping data in the statistical computer model. And, the method can further be comprised of performing a calculation with a computer by using the statistical computer model to determine a customer loyalty and/or a financial return-on-investment indicia for the targeted business.

In accordance with another embodiment, a method of evaluating a targeted business of a particular business type can be comprised of obtaining mystery shopping data for the targeted business; obtaining customer satisfaction data for the targeted business, wherein the obtaining customer satisfaction data for the targeted business comprises: obtaining generic industry-visit frequency data indicating how often a surveyed customer visits any business of the particular business type during a specified time period; and obtaining targeted-business-visit frequency data indicating how often the surveyed customer visits the targeted business during the specified time period. The method can be further comprised of inputting the mystery shopping data, the generic-visit frequency data, and the targeted-business-visit frequency data into a computer.

In accordance with yet another embodiment, a method of calculating the impact of customer satisfaction on a targeted business can be comprised of implementing with a computer a computer model of a targeted business, the computer model based on data from at least one mystery shopping survey and at least one customer satisfaction survey; inputting initial operational data for the targeted business into the computer for use by the computer model for the targeted business; calculating an initial customer loyalty indicia for the targeted business using the computer model and the initial operational data; and determining the effect on the initial customer loyalty indicia caused by a change to the initial operational data.

In accordance with another embodiment, a method can be comprised of implementing with a computer a computer model of a targeted business, the computer model based on data from at least one mystery shopping survey and at least one customer satisfaction survey; determining from sales data and the computer model an estimate of customers that are at risk of not returning to the targeted business; and calculating a loss in revenue based upon the estimate.

In accordance with another embodiment, a method can be comprised of implementing with a computer a computer model of a targeted business, the computer model based on data from at least one mystery shopping survey and at least one customer satisfaction survey; determining from sales data and the computer model an estimate of the change in financial performance (e.g., same store sales data); and calculating a loss or gain in revenue based upon the estimate.

Further embodiments of the invention will be apparent from a review of the entire specification, including the drawings.

### BRIEF DESCRIPTION OF THE DRAWINGS

FIG. 1 illustrates an example of a structural equation model that includes both customer satisfaction survey data and mystery shopping survey data in accordance with one embodiment.

FIG. 2 illustrates standardized regression weights and factor score weights for the example shown in FIG. 1.

FIG. 3 illustrates another structural equation model that not only shows the effect on customer loyalty, but also the effect on visits and sales, in accordance with one embodiment.

FIG. 4 illustrates an example of data inputs for an industry sector in accordance with one embodiment of a financial calculator.

FIG. 5 illustrates loyalty driver inputs for a financial calculator in accordance with one embodiment.

FIG. 6 illustrates a financial calculator for computing “What-If” scenarios in accordance with one embodiment.

FIG. 7 illustrates risk estimates for a loyalty model in accordance with one embodiment.

FIG. 8 illustrates a block diagram of a computer system that can be utilized to implement the computer and software described herein in accordance with one embodiment.

FIG. 9 illustrates a flow chart demonstrating a method of utilizing mystery shopping data and customer satisfaction data to determine customer loyalty in accordance with one embodiment.

FIG. 10 illustrates a flow chart demonstrating a method of utilizing mystery shopping data and customer satisfaction data to determine customer loyalty in accordance with another embodiment.

FIG. 11 illustrates a flow chart demonstrating a method of determining an effect on initial customer loyalty in accordance with one embodiment.

FIG. 12 illustrates a flow chart demonstrating a method of determining a loss in revenue for a targeted business in accordance with one embodiment.

### DETAILED DESCRIPTION

Mystery shopping is an industry under development in today's marketplace. It is used to assess the performance of a business through the use of independent shoppers (“mystery shoppers”) who are engaged to visit a particular target business and to assess the operational characteristics of that business. The mystery shoppers themselves are not drawn to a particular business out of any pre-existing loyalty or pre-disposition toward the business. Rather, they are engaged to visit the business and to provide an independent analysis of the operational characteristics of that business. They can be employees or independent contractors of a mystery shopping survey company, for example. Furthermore, they are engaged to visit the store incognito so that the store personnel are not aware that any particular shopper is in actuality a mystery shopper. This secrecy helps to ensure normal shopping conditions and normal treatment of the customers by store personnel. Thus, mystery shopping entails the engagement of at least one individual to visit a business incognito to assess at least one operational characteristic of a business.

With the advent of mystery shopping, businesses can now better assess the impact of operational changes on customer loyalty. In the past, an estimate of the impact that a change in business operations would have on customer loyalty was limited to actual customer satisfaction data. Furthermore, in the past, mystery shopping data was merely used to provide static statistics about the performance of a business. The data was not used in a dynamic manner to assess how changes in the measured operational characteristics of the business would impact customer loyalty. However, in accordance with one embodiment of the invention, mystery shopping data can now be used to provide a more accurate estimation of how changes in certain business operations will change customer loyalty, customer satisfaction, and/or financial return.

In accordance with one embodiment of the invention, a computerized system is utilized to combine both customer satisfaction data with mystery shopping data in order to determine the effect on customer loyalty. Such a system can be implemented by utilizing a computer and software program that receives an input data set of actual customer satisfaction data and an input data set of mystery shopper survey data. For purposes of this application, an “actual customer” shall be a customer that visits a business of his or her own accord without being engaged to do so, whereas a “mystery shopper” shall be a shopper who visits a business for the purpose of mystery shopping. Both data sets are provided as inputs to the computer. Furthermore, the software program allows as an input a change to an operational characteristic of the business. The software program can then calculate a result that indicates the effect that such a change on the operational characteristic will have on the customer loyalty for the business, customer satisfaction for the business, and/or financial return for the business. Furthermore, the software program can calculate the effect on other business performance characteristics, such as gross profit, net profit, inventory, etc.

A five-step process can be utilized to implement a method in accordance with one embodiment. As a first step, one can collect customer satisfaction data from customer surveys. Any methodology may be used to collect the survey data, such as online web surveys, computer assisted telephone interviewing (CATI), interactive voice response (IVR), or mail. The customer satisfaction survey will typically include at least the following four types of questions: 1) number of trips or shopping experiences within a given industry during a specific time period; 2) number of trips/shopping experiences at a specific brand or at a specific business location; 3) likelihood to return to a given brand or location; and 4) relative satisfaction with the experience.

A second step in the five-step process is to collect mystery shopping data measuring operational performance. Typically, the mystery shopping data should include the following two questions: 1) likelihood to return to a given location; and 2) relative satisfaction with the experience. By having the same question structures on both the customer satisfaction survey and the mystery shopper survey, new statistical options are made available for correlating the customer satisfaction data and mystery shopping data.

As a third step, a precise statistical model demonstrating impacts of customer satisfaction and operational performance data on loyalty can be created. As a fourth step, a financial calculator can be created that allows users to create different scenarios to assess the possible changes that can occur in customer loyalty when different operational inputs are changed. Essentially, the user can perform different “what-if” scenarios. And, as a fifth step, the user can refresh the model based on new inputs.

To implement the method described above, a computerized system can be utilized. The computerized system may be comprised, for example, of a database that integrates all data. Each data element is identified as belonging to a particular store or reporting hierarchy (e.g., region). Statistical code may be utilized for the identifying and categorizing of the data elements. Furthermore, the code may be utilized to create new variables or elements. The statistical model for the system may be created using structural equation modeling. This model should typically be a “best fit” model that accounts for as much error as possible. The outputs of the model can be the relative effects on loyalty and financial return, where financial return is a specific metric germane to both the client's industry and the individual client. A series of input variables from an industry or a specific client representing financial data can be utilized as the input to the model. This data should typically include basket size, revenue, profit, and/or estimated number of customers. The statistical model will produce a series of input variables. These variables are the effect sizes or impact of any given variable on loyalty. An interactive calculator can be used to construct “what-if” scenarios for making changes to operational performance metrics. And, an output can summarize financial impacts of the “what-if” scenarios.

It has been noted that one reason that it has been difficult in the past to combine customer satisfaction data with mystery shopping data is that customer satisfaction data is typically collected as scaled data points, e.g., questions are often answered on a scale of 1 to 7. In contrast, mystery shopping data has historically been collected as “yes” or “no” answers (categorical data). In accordance with one embodiment of the invention, the mystery shopping data is also collected having some scaled answers and some “yes”/“no” answers. In addition, the specific modeling techniques allow the use of both scaled and categorical variables. Thus, when the data results are modeled, the mystery shopping data can more accurately be related to the customer satisfaction data from the actual customers.

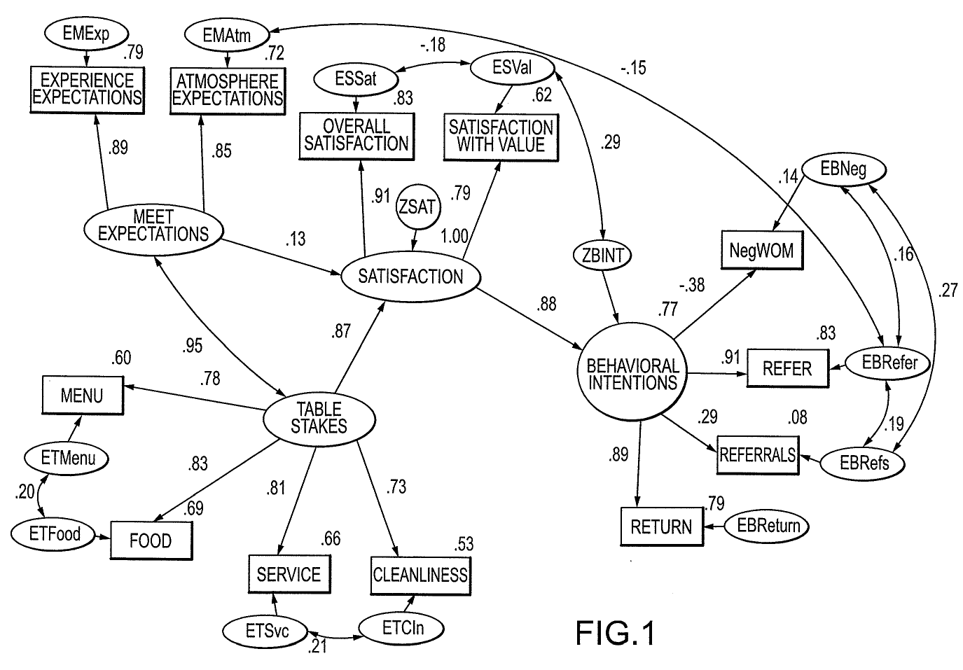

Referring now to FIG. 1, an example of a model in accordance with one embodiment can be seen. FIG. 1 shows a model for a food service business. The model includes not only customer satisfaction data, but also mystery shopping data (i.e., operational data gathered by independent shoppers engaged as incognito or secret shoppers for the purpose of gathering survey data). The customer satisfaction data on the other hand is typically gathered through a survey of actual customers. Actual customers are asked to rate their satisfaction level on a qualitative scale. For example, one question might ask whether the actual shopper found the shopping experience at the store to be positive or negative on a scale of 1-10. In contrast, the survey data obtained from mystery shoppers focuses on operational characteristics of the store. For example, the mystery shopper might be asked whether the food service employee wore gloves or not. Preferably, such mystery shopper survey operational questions have “yes” or “no” answers so as to avoid subjectivity and to promote objectivity. However, in some instances mystery shoppers also provide qualitative assessments by answering according to a scale. Thus, the model promotes both subjective responses from the actual customers and objective answers from the independent mystery shoppers.

The sample structural equation model shown in FIG. 1 uses answers to mystery shopper survey questions about “menu,” “food,” “service,” and “cleanliness,” as well as answers to actual customer survey questions regarding “experience expectations,” “atmosphere expectations,” “overall satisfaction,” and “satisfaction with value” in order to compute the effect on customer loyalty. The computation is based on a model prepared by a statistician. The square boxes shown in FIG. 1 represent operational performance metrics. The small ellipses represent the error terms or interaction between variables. In the example shown in FIG. 1 a model for a restaurant is shown. The operational performance metrics for a restaurant in this example include “menu,” “food,” “service,” and “cleanliness.” Each metric has an effect on the general category labeled as “table stakes.” Thus, for example, the metric of menu has an effect of 0.78 on the table stakes factor whereas the metric of “food” has an effect of 0.69 on the table stakes factor.

The square boxes in FIG. 1 of “experience expectations,” “atmosphere expectations,” “overall satisfaction,” and “satisfaction with value” are metrics from the customer satisfaction surveys of actual customers. The small ellipses coupled to these boxes represent error values for these metrics. Furthermore, the large ellipses represent general categories. Thus, “experience expectations” and “atmosphere expectations” can be determined from the customer satisfaction survey, and those values can be used to calculate a value for the “meet expectations” category.

The model shown in FIG. 1 allows behavioral intentions to be computed which can predict how a customer will behave. Thus, for example, a change in value for the customer's response to cleanliness will translate to a change in the outputs of NegWOM (negative word of mouth), Refer (whether the customer will refer another to the store), Referrals (how many referrals would the customer make), and Return (would the customer return to the store or not).

When using a structural equation model, the statistician can utilize best fit techniques with the mystery shopping data and customer satisfaction data to achieve the best model of the targeted business.

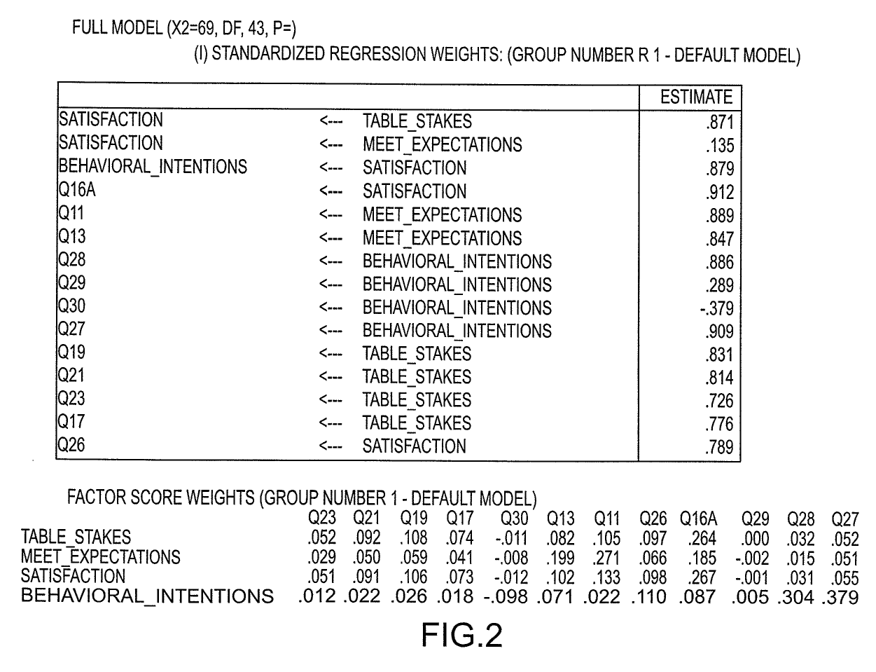

FIG. 2 illustrates standardized regression weights and factor score weights for the structural model shown in FIG. 1.

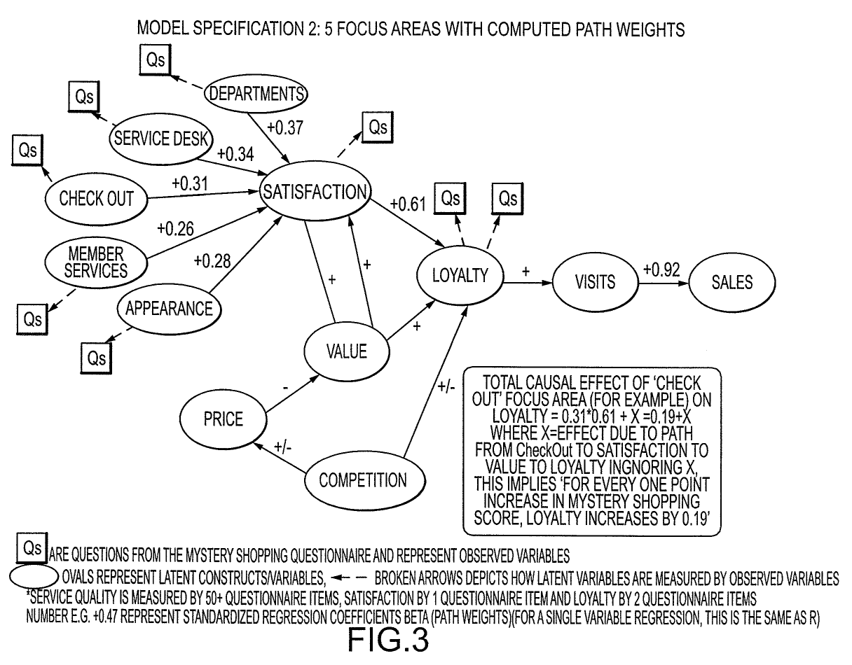

FIG. 3 is an example of a structural equation model for a “check out” store. This example illustrates the effect that various operational changes can have on customer loyalty, store visits, and actual sales. Again, the model is based on both actual customer satisfaction survey data and mystery shopping survey data. These two data sets are utilized by the model to compute an effect on customer loyalty. As noted in FIG. 3, the structural equation model illustrates how a change in the mystery shopping score will impact customer loyalty.

Once the models are determined for a particular business or industry and once the input data has been gathered, a business can perform “what-if” scenarios to determine the effect that a change in operations will have on customer loyalty. For example, one could determine the effect that an investment in delivering food within 8 minutes instead of 10 minutes would have on loyalty and hence on profit.

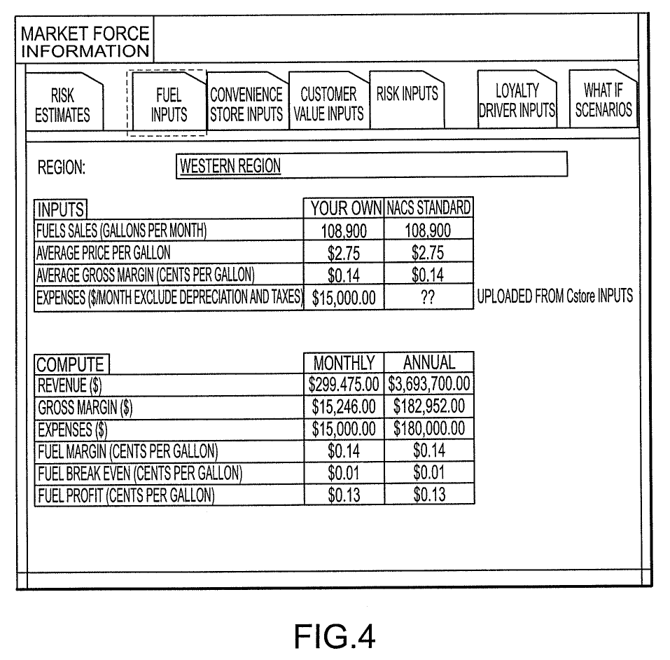

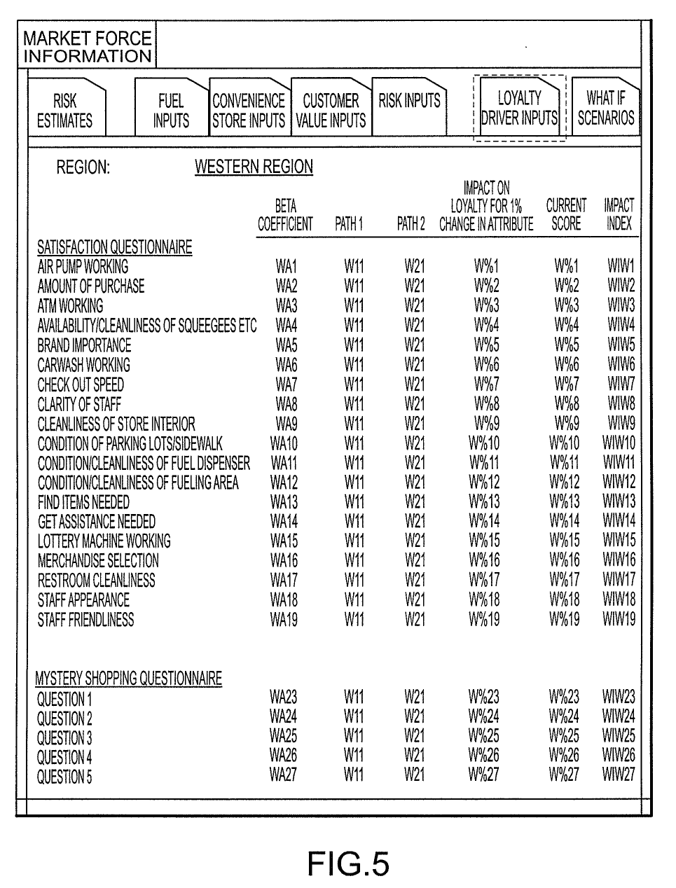

FIGS. 4, 5, 6, and 7 illustrate examples of data and calculations that can be performed for a gas station in accordance with one embodiment of the invention. FIG. 4 illustrates an example of industry information for a model. In this case, FIG. 4 shows the fuel input information relating to fuel sales and costs for a gas station. Other inputs can include data for the convenience store at the gas station, customer value inputs, and risk inputs. In addition, risk estimates can be included to calculate the effect of risk on computed information. FIG. 5 illustrates the loyalty driver inputs. Essentially, the loyalty driver inputs relate to the customer satisfaction survey data and the mystery shopping survey data. This data can be input for the structural equation model. As can be seen, FIG. 5 can illustrate the impact on loyalty caused by a % change in an attribute. And, the impact index can be used to rank the attributes that impact loyalty the most.

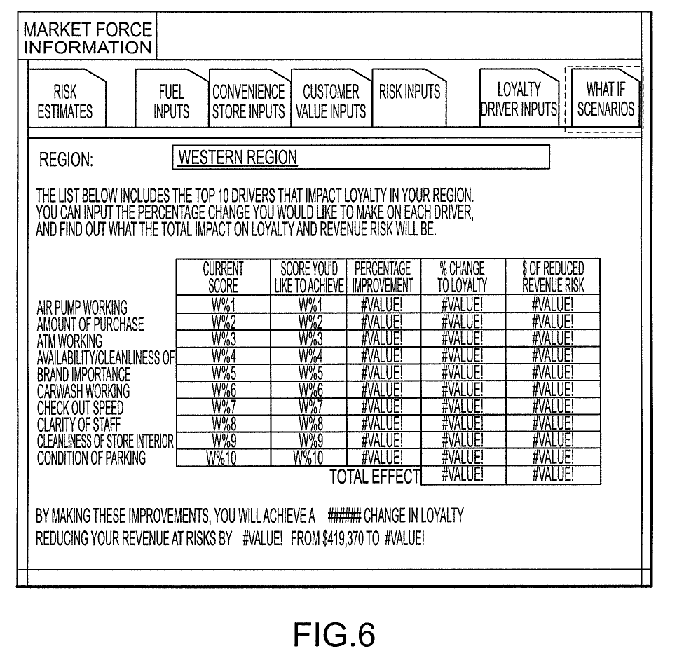

FIG. 6 illustrates an example of a graphical user interface for a financial calculator. The calculator can be utilized by a business to run “what-if” scenarios. It allows the previously described models to be used to estimate how changing a particular loyalty driver will impact loyalty and revenue. For example, it allows one to determine how improving cleanliness of store interior will affect loyalty and what the amount of money in reduced revenue risk will be.

For example, as shown by FIG. 6, the current scores for different operational parameters of a targeted business could be displayed for a business owner. The owner could then enter the score he/she would like to achieve for that category. The program could then calculate and display the percentage improvement. Moreover, using the computer model, the program could calculate the impact on customer loyalty that the changes would achieve and then display those in the “% Change to Loyalty” category. Furthermore, using the computer model, the program could also calculate the impact on profit and thus display the impact on revenue—this is shown as “$ of Reduced Revenue Risk” in FIG. 6. In addition, a total change in the loyalty score can be calculated with the computer model and displayed. And, a total reduction in revenue at risk can also be displayed. This allows a business owner to perform what-if scenarios to determine how different investments to achieve improved scores will impact customer loyalty and the related impact on sales and profit.

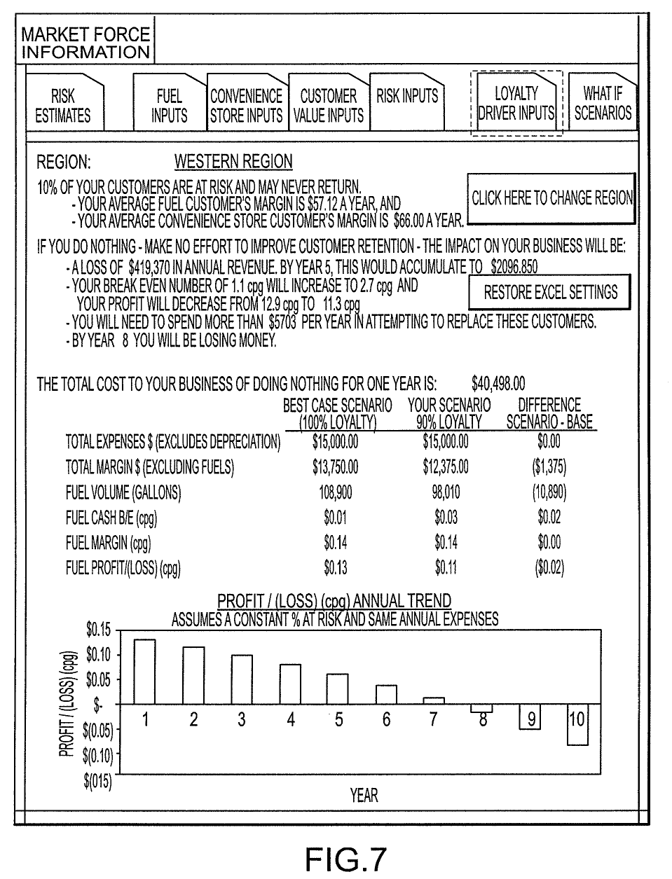

FIG. 7 illustrates a summary of the risk faced by a business. For example, the graphical user interface can indicate the percentage of customers that are at risk of not returning based on current inputs. Similarly, financial returns for a store can be calculated based on customer retention.

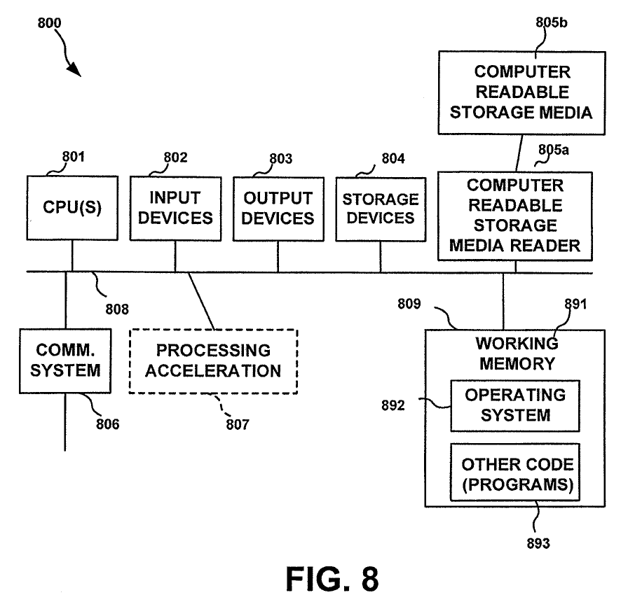

To implement the system described above, a computerized system such as that shown in FIG. 8 can be used. Namely, FIG. 8 broadly illustrates how individual system elements can be implemented. System 800 is shown comprised of hardware elements that are electrically coupled via bus 808, including a processor 801, input device 802, output device 803, storage device 804, computer-readable storage media reader 805a, communications system 806 processing acceleration (e.g., DSP or special-purpose processors) 807, and memory 809. Computer-readable storage media reader 805a is further coupled to computer-readable storage media 805b, the combination comprehensively representing remote, local, fixed, and/or removable storage devices plus storage media, memory, etc., for temporarily and/or more permanently containing computer-readable information, which can include storage device 804, memory 809, and/or any other such accessible system 800 resource. System 800 also comprises software elements (shown as being currently located within working memory 891), including an operating system 892 and other code 893, such as programs, applets, data, and the like.

System 800 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 800 component (e.g., within communications system 806). Customized hardware might also be utilized and/or particular elements might be implemented in hardware, software (including so-called “portable software,” such as applets), or both. Further, while connection to other computing devices such as network input/output devices (not shown) may be employed, it is to be understood that wired, wireless, modem, and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g., computer, appliance, portable device, etc.). Not all system 800 components will necessarily be required in all cases.

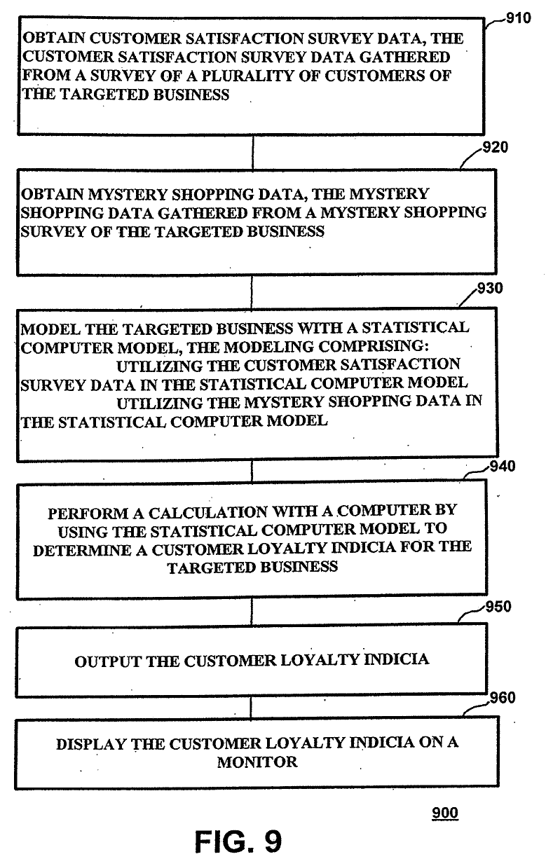

Referring now to FIG. 9, a flowchart 900 illustrating a method of utilizing mystery shopping data to determine the effect on customer loyalty can be seen. In flowchart 900, customer satisfaction data is obtained for a targeted business. A targeted business is understood to mean the business that is being analyzed. The customer satisfaction data can be obtained through the use of customer satisfaction surveys. The surveys can be conducted by the same company that analyzes customer loyalty or by a separate data-gathering company. The data can be gathered via multiple surveys of multiple customers. The customers can report for example what their experiences were at the targeted business on a scale of 1-7. The data can thus serve as scaled data on a continuous scale. In addition, the data can be gathered in person or using online or telephone survey techniques, for example.

In order to be able to gauge the existing loyalty of the customer as well as the market share that the targeted business has, the customer is also asked four additional questions as part of the customer satisfaction survey. The first two questions are used to assess loyalty by comparing the frequency of shopping done by the customer in a particular business category versus the frequency of shopping done by the customer at a specific business operator's location. (When a brand rather than a specific business location is being studied, the customer can be asked how often he/she shops at the brand locations rather than a specific business location.) The two questions include: (1) how many times the customer shops at the particular store(s) being analyzed over a given time period; and (2) how many times the customer shops at the category of business that the particular store(s) falls under during a given time period. For example, the customer could be asked how many times he or she shops at a particular grocery store (or any Safeway grocery store, if the brand is being studied). And, the customer could also be asked how many times during the month the customer shops for groceries at any grocery store. These questions allow the model to determine the effect of the model on a dependent variable, e.g., customer loyalty. Two additional questions are used to gauge existing loyalty: 1) the customer's satisfaction with the overall experience; and 2) the customer's likelihood of returning to the specific business location (or brand location if brand is being studied).

In block 920, mystery shopping data can be obtained. Mystery shopping data typically will be comprised of answers to categorical questions. For example, “yes”/“no” answers are typically provided by the mystery shopper in response to questions about the operational characteristics of the targeted business. Thus, these categorical answers are not the same as the scaled data obtained in the customer satisfaction data. For example, the mystery shopper might be asked if the bathrooms were clean. Or, the mystery shopper might be asked whether the clerk asked if the shopper found everything he/she was looking for. In addition to the categorical questions, mystery shopping data can also include some customer satisfaction questions based on a predetermined continuous scale, e.g., answers based on a scale between 1-7. Thus, for example, the mystery shopper can be asked about: 1) the mystery shopper's satisfaction with the overall experience; and 2) the mystery shopper's likelihood of returning to the specific business location (or brand location if brand is being studied). These scaled answers help the statistician modeling the targeted business to relate the mystery shopping data with the data from the customer satisfaction surveys. The relationship between mystery shopping and customer satisfaction is established by correlating mystery shopping satisfaction data with customer satisfaction data, merging the data by a unit of time as well as by geographic location.

The mystery shopping questionnaire used by the mystery shoppers will typically focus on three areas: compliance, revenue generation, and customer satisfaction. In addition, the number of data points per questionnaire gathered by the mystery shopper may be much larger and more detailed relative to a customer satisfaction survey. For example, a mystery shopping survey might ask 35 questions every month, whereas a customer satisfaction survey questionnaire might ask 10 questions every month. In addition, the mystery shopping surveys may be performed less frequently than the customer satisfaction surveys.

In block 930, customer loyalty of the targeted business is modeled with a statistical computer model. The statistical model can be built using both the data from the customer satisfaction survey(s) and the data from the mystery shopper survey(s). FIG. 1 illustrates an example of a model generated using structural equation modeling techniques. More information on structural equation modeling can be found in the book Kline, R. B. (2005) Principles and Practice of Structural Equation Modeling, The Guilford Press, ISBN 1-57230-690-4. Similarly, FIG. 3 illustrates a model. By use of such models, dependent variables can be modeled and studied. For example, the dependent variables of 1) customer satisfaction; 2) loyalty; and 3) financial return (e.g., gross margin, same store sales, basket size, visits, etc.) can be modeled and studied. As a result of implementing the model based on the customer satisfaction data and the mystery shopping data, outputs for these dependent variables can be generated and used (e.g., displayed on a display). For example, in block 940, a computer can be utilized to determine a customer loyalty indicia (e.g., a customer loyalty score) for the targeted business. Moreover, the customer loyalty indicia can be used to indicate the effect that a change in an operational characteristic of the targeted business has on customer loyalty in accordance with the statistical computer model.

The computer can then generate an output of the customer loyalty indicia as indicated by block 950. For example, the computer can display the loyalty indicia on a monitor, as shown by block 960.

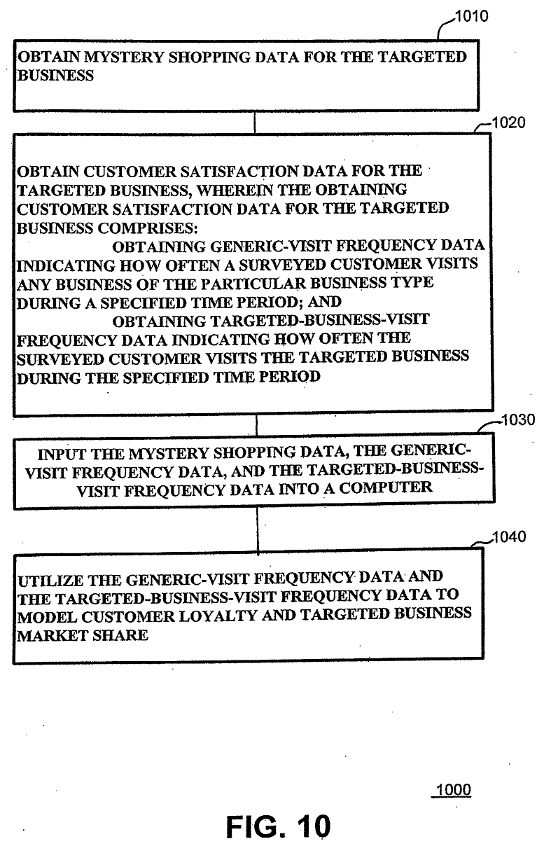

FIG. 10 illustrates a flowchart 1000. In block 1010, mystery shopping data is obtained for a targeted business. In block 1020, customer satisfaction data is obtained for the targeted business. The customer satisfaction data may include data relating to four questions that will help assess customer loyalty. For example, the customer can be asked how often they visit any store of a particular business category—for example, how often they buy gas or supplies. And, the customer can be asked a second question of how often they visit the targeted business—for example, how often they visit “Ted's Filling Station” to buy gas or supplies. In addition, the customer can be asked how likely they are to return to the targeted store and how satisfied they were with their experience at the targeted store.

Once the data is obtained, it can be input into a structural equation model. Thus, block 1030 illustrates that the mystery shopping data and customer satisfaction data, such as the generic-visit frequency data and the targeted-business frequency data can be input into a computer for use with structural equation modeling techniques. Block 1040 shows that the data can be used to model customer loyalty and targeted business market share.

Once a computer model has been determined for a targeted business, the computer model can be used to calculate “what-if” scenarios. For example, the computer can be used to determine how much of the targeted business' sales are at risk of being lost if customer loyalty is not improved. Or, the calculator might be used to determine what effect an investment in an operational characteristic (such as cleaning the bathrooms more often) would have on profit. Moreover, the calculator might be used to determine which operational characteristics should be improved to achieve the greatest improvement in profit for the investment. Thus, rather than telling the targeted business to improve its overall score, the targeted business could be counseled to improve specific operational characteristics. This would be a big improvement over current systems that simply monitor customer satisfaction and its effect on customer loyalty without any ability to link operational performance variables to customer satisfaction and customer loyalty, thus indicating the effect of those operational variables on customer loyalty and hence on future profit. Rather, others have primarily focused on customer satisfaction perceptions without linking to the behavioral mystery shopping data.

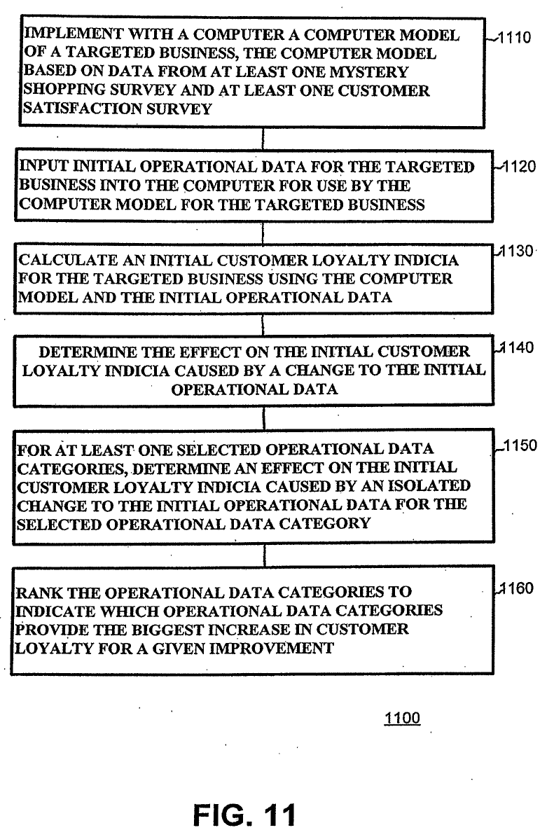

FIG. 11 illustrates a flow chart 1100 for implementing one such calculator. In block 1110, a computer model for the targeted business is implemented. The computer model is based on data from at least one mystery shopping survey and at least one customer satisfaction survey. In block 1120, initial operational data for the targeted business is input into the computer. The computer model will then be able to operate on the operational data. For example, in block 1130, an initial customer loyalty indicia for the targeted business can be computed using the computer model and the initial operational data. Thus, for example, an initial customer loyalty score can be calculated. The calculator would demonstrate to an operator of the targeted business what type of customer loyalty could be expected for given operational conditions. Similarly, by investing in the business to change one of those parameters, the calculator could determine the financial change in profit. For example, the calculator could determine that by investing $10,000 to improve the cleanliness of the business that customer loyalty would improve by “x” percent and that change would result in additional sales of “y” dollars Thus, block 1140 shows how a change to the initial operational data can affect the initial customer loyalty indicia. Similarly, by using the computer model, the computer could determine which of the operational data characteristics would produce the biggest change to customer loyalty and hence the biggest change to profit. This could be accomplished by analyzing the coefficients used in the computer model or by simply comparing how big an effect an investment in each operational characteristic would have while the other operational characteristics are not changed. After each characteristic is evaluated, the corresponding changes in customer loyalty could be compared in order to determine which operational characteristics produced the biggest effect on customer loyalty. A list of these operational characteristics could then be displayed for the business owner so that the business owner can evaluate the choices. For example, the list for a supermarket might say:

1) Improve security in parking lot;

2) Reduce waiting in line time;

3) Improve appearance of personnel;

4) Reduce time that obstacles are in aisles caused by re-stocking.

Also, see FIG. 6 for an example for a gas station.

As noted above, blocks 1150 and 1160 illustrate that for at least one selected operational data category, an effect on the initial customer loyalty indicia can be determined that would be caused by a change to the initial operational data for the selected operational data category. And, the operational data categories can be ranked to indicate which of the operational data categories provide the biggest increase in customer loyalty for a given improvement.

Furthermore, one can run what-if scenarios to determine how much more profit can be obtained by an investment in the selected operational characteristic. For example, one could see how much more profit could be made by improving mystery shopping scores for the parking lot. Moreover, the computer would be able to calculate a return on investment, as would be understood by one of ordinary skill in the art.

The calculator allows one to identify particular operational characteristics that should be improved rather than a generalized characteristic. For example, in a typical customer satisfaction analysis, friendliness is often evaluated. The customer satisfaction surveys in some cases contain only one question about friendliness. When the business owner receives the results of such analyses of the customer satisfaction data, the business owner is usually only told to improve friendliness. There is no identification of which specific behaviors would produce the greatest return on improving friendliness. A mystery shopping questionnaire in some cases might contain five to eight questions about friendliness. By modeling the mystery shopping behavioral data to the customer satisfaction behavioral data, the business owner will understand what specific behaviors to improve in order to improve friendliness. In accordance with one embodiment, particular friendliness behaviors can be identified for the business owner to target. This is because those characteristics can be modeled for their effect on both customer satisfaction and customer loyalty.

As another example of how the computer model can be used, given the initial operational characteristics and the computer model, one could calculate how many customers are currently being lost if the business remains at status quo. Moreover, one could then determine how much revenue was being lost due to lost customers. And, one could calculate how much investment should be made to retain customers and retain profit. Additional scenarios could then be run to determine the optimum investment that one should perform in order to achieve an improvement in profit by a stated time period, as would be understood by one of ordinary skill in the art.

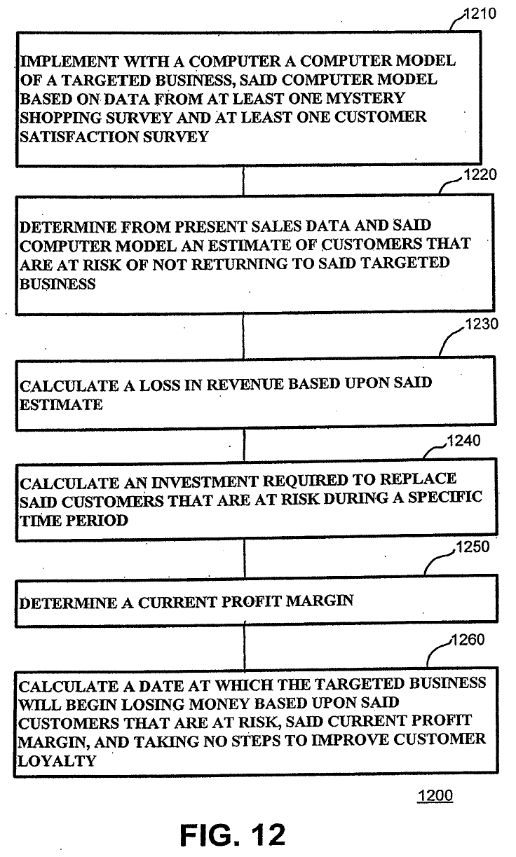

For example, one such “what if” calculator method is illustrated by FIG. 12 and FIG. 7. In flowchart 1200 of FIG. 12, one can use a computer model to model a targeted business. The model might be obtained from a model consultant, such as Market Force Information of Boulder, Colo. The computer model can be based on data from at least one mystery shopping survey directed at the targeted business and at least one customer satisfaction survey directed at the targeted business, as shown by block 1210. Using the computer model and present sales data, one could estimate how many of the customers are at risk of not returning to the targeted business, as shown by block 1220. The result could be displayed on a computer display as shown in FIG. 7. Block 1230 shows that a loss in revenue based upon the estimated revenue at risk could be calculated. Similarly, it could be displayed on the display. And, block 1240 shows that the program could calculate and display the investment required to replace the customers that are at risk during a specific time period—for example, the investment needed to improve customer loyalty and/or financial return such as same store sales.

Block 1250 shows that a current profit margin can be calculated and displayed. A profit margin for future years can be calculated under the assumption that no changes are made. As a result, the decreasing profit margin will eventually show a negative profit for the business, as shown at the bottom of FIG. 7. Thus, block 1260 indicates that a date at which the targeted business will begin losing money based upon the customers that are at risk, the current profit margin, and by taking no steps to improve customer loyalty can be calculated and displayed.

The determination of what places a customer at being at risk of not returning can be based upon predetermined standards. For example, the percentage of customers that are both highly satisfied and highly loyal are deemed likely to return to the store. And, for example, those that are both highly dissatisfied and highly disloyal are deemed to be at risk.

The calculators can be utilized by business operators. This could be implemented by downloading the data for use by the statistical model as the statistical model is updated. For example, as new mystery shopping data is obtained over future time periods, the computer model for the business could be updated by the statistician. Then, the coefficients for the model (such as those shown in FIG. 1) can be downloaded to the business owner's computer so that the business owner is operating with the most recent data.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in the program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or step for performing a function. Therefore, it should be understood that such language is entitled to cover all such structures, materials, or acts disclosed within this specification and their equivalents.

It is thought that the apparatuses and methods of embodiments of the present invention and its attendant advantages will be understood from this specification. While the above description is a complete description of specific embodiments of the invention, the above description should not be taken as limiting the scope of the invention as defined by the claims.

What is claimed is:

1. A method of evaluating a targeted business, said method comprising.

2. Obtaining customer satisfaction survey data, said customer satisfaction survey data gathered from a survey of a statistically significant sample of customers of said targeted business;
obtaining mystery shopping data, said mystery shopping data gathered from a mystery shopping survey of said targeted business;
modeling said targeted business with a statistical computer model, said modeling comprising:
utilizing said customer satisfaction survey data in said statistical computer model;
utilizing said mystery shopping data in said statistical computer model
performing a calculation with a computer by using said statistical computer model to determine a customer loyalty indicia for said targeted business.

3. The method as in claim 1 and further comprising:
outputting said customer loyalty indicia.

4. The method as in claim 1 and further comprising:
displaying said customer loyalty indicia on a monitor.

5. The method as in claim 1 wherein said customer loyalty indicia indicates the effect that a change in an operational characteristic of said targeted business has on customer loyalty in accordance with said statistical computer model.

6. The method as in claim 1 wherein said modeling said targeted business with said statistical computer model comprises:
modeling said targeted business with a structural equation model.

7. The method as in claim 1 wherein said customer satisfaction survey data is scaled upon a pre-defined continuous scale.

8. The method as in claim 1 wherein said mystery shopping data comprises categorical data.

9. The method as in claim 1 wherein said mystery shopping data comprises continuous data and also comprises categorical data.

10. The method as in claim 1 wherein said customer satisfaction survey data is scaled upon a pre-defined continuous scale and wherein said mystery shopping data comprises categorical data.

11. A method of evaluating a targeted business of a particular business type, said method comprising:
obtaining mystery shopping data for said targeted business;
obtaining customer satisfaction data for said targeted business, wherein said obtaining customer satisfaction data for said targeted business comprises:
obtaining generic-visit frequency data indicating how often a surveyed customer visits any business of said particular business type during a specified time period; and
obtaining targeted-business-visit frequency data indicating how often said surveyed customer visits said targeted business during said specified time period;
inputting said mystery shopping data, said generic-visit frequency data, and said targeted-business-visit frequency data into a computer.

12. The method as in claim 10 and further comprising:
utilizing said generic-visit frequency data and said targeted-business-visit frequency data to model customer loyalty and targeted business market share.

13. The method as in claim 10 and further comprising:
inputting said mystery shopping data, said generic-visit frequency data, and said targeted-business-visit frequency data into a structural equation model.

14. A method of calculating the impact of customer satisfaction on a targeted business, said method comprising:
implementing with a computer a computer model of a targeted business, said computer model based on data from at least one mystery shopping survey and at least one customer satisfaction survey;
inputting initial operational data for said targeted business into said computer for use by said computer model for said targeted business;
calculating an initial customer loyalty indicia for said targeted business using said computer model and said initial operational data;
determining the effect on said initial customer loyalty indicia caused by a change to said initial operational data.

15. The method as in claim 13 and further comprising:
pre-defining operational data categories for said targeted business;
inputting initial operational data for at least one of said operational data categories;
for at least one selected operational data category, determining an effect on said initial customer loyalty indicia caused by an isolated change to said initial operational data for said selected operational data category.

16. The method as in claim 14 and further comprising:
ranking the operational data categories to indicate which operational data categories provide the biggest increase in customer loyalty for a given improvement.

17. A method comprising:
implementing with a computer a computer model of a targeted business, said computer model based on data from at least one mystery shopping survey and at least one customer satisfaction survey;
determining from sales data and said computer model an estimate of customers that are at risk of not returning to said targeted business;
calculating a loss in revenue based upon said estimate.

18. The method as in claim 16 and further comprising:
calculating an investment required to replace said customers that are at risk during a specific time period.

19. The method as in claim 16 and further comprising:
determining a current profit margin;
calculating a date at which the targeted business will begin losing money based upon said customers that are at risk, said current profit margin, and taking no steps to improve customer loyalty.

20. An article of manufacture comprising:
a computer usable medium having computer readable program code means embodied therein, the computer readable program code means in said article of manufacture comprising:
computer readable program code means for causing a computer to effect obtaining customer satisfaction survey data, said customer satisfaction survey data gathered from a survey of a plurality of customers of said targeted business;
computer readable program code means for causing the computer to effect obtaining mystery shopping data, said mystery shopping data gathered from a mystery shopping survey of said targeted business;
computer readable program code means for causing the computer to effect modeling said targeted business with a statistical computer model, said modeling comprising:
computer readable program code means for causing the computer to effect utilizing said customer satisfaction survey data in said statistical computer model;
computer readable program code means for causing the computer to effect utilizing said mystery shopping data in said statistical computer model
computer readable program code means for causing the computer to effect performing a calculation with the computer by using said statistical computer model to determine a customer loyalty indicia for said targeted business.

21. An article of manufacture comprising:
a computer usable medium having computer readable program code means embodied therein, the computer readable program code means in said article of manufacture comprising:
computer readable program code means for causing a computer to effect obtaining mystery shopping data for said targeted business;
computer readable program code means for causing the computer to effect obtaining customer satisfaction data for said targeted business, wherein said obtaining customer satisfaction data for said targeted business comprises:
computer readable program code means for causing the computer to effect obtaining generic-visit frequency data indicating how often a surveyed customer visits any business of said particular business type during a specified time period; and
computer readable program code means for causing the computer to effect obtaining targeted-business-visit frequency data indicating how often said surveyed customer visits said targeted business during said specified time period;
computer readable program code means for causing the computer to effect inputting said mystery shopping data, said generic-visit frequency data, and said targeted-business-visit frequency data into a computer.

22. An article of manufacture comprising:
a computer usable medium having computer readable program code means embodied therein, the computer readable program code means in said article of manufacture comprising:
computer readable program code means for causing a computer to effect implementing with a computer a computer model of a targeted business, said computer model based on data from at least one mystery shopping survey and at least one customer satisfaction survey;
computer readable program code means for causing the computer to effect inputting initial operational data for said targeted business into said computer for use by said computer model for said targeted business;
computer readable program code means for causing the computer to effect calculating an initial customer loyalty indicia for said targeted business using said computer model and said initial operational data;
computer readable program code means for causing the computer to effect determining the effect on said initial customer loyalty indicia caused by a change to said initial operational data.

23. An article of manufacture comprising:
a computer usable medium having computer readable program code means embodied therein, the computer readable program code means in said article of manufacture comprising:
computer readable program code means for causing a computer to effect implementing with a computer a computer model of a targeted business, said computer model based on data from at least one mystery shopping survey and at least one customer satisfaction survey;
computer readable program code means for causing the computer to effect determining from sales data and said computer model an estimate of customers that are at risk of not returning to said targeted business;
computer readable program code means for causing the computer to effect calculating a loss in revenue based upon said estimate.
